(19) United States
(12) Patent Application Publication
(10) Pub. No.: US 2017/0169728 A1
(43) Pub. Date: Jun. 15, 2017

(54) POKER TRAINING SYSTEM AND METHOD

(71) Applicant: Aces Raise, Silver Spring, MD (US)

(72) Inventor: Joshua I. Silverstone, Silver Spring, MD (US)

(21) Appl. No.: 15/378,749

(22) Filed: Dec. 14, 2016

Related U.S. Application Data
(60) Provisional application No. 62/267,139, filed on Dec. 14, 2015.

(51) Int. Cl. G09B 19/22; A63F 1/00; G09B 5/02

(52) U.S. Cl. CPC G09B 19/22; G09B 5/02; A63F 1/00; A63F 2001/005

(57) ABSTRACT

In one embodiment, the invention can be a method for providing poker training, the method including displaying to a user a starting poker hand, community cards, a pot value, and a bet value required to call; prompting the user to answer whether to call or fold based on an equity and a pot odds associated with the user's starting poker hand; displaying a current score based on the user's answer to call or fold; and repeating the foregoing steps for additional starting poker hands, community cards, pot values, and bet values.

### CROSS REFERENCE TO RELATED APPLICATIONS

The present application claims the benefit of U.S. Provisional Patent Application No. 62/267,139 filed on Dec. 14, 2015, which is incorporated herein by reference.

### BACKGROUND

Poker games such as Texas hold'em have become increasingly popular. With this popularity, there is increased interest in poker training methods to enhance players' skills. Existing methods, however, have several shortcomings. For example, such methods do not enable a player to assess the pot value, the opponent bet, and the current cards to determine whether to call or fold.

### BRIEF SUMMARY

The present disclosure may be directed, in one aspect, to a non-transitory computer-readable storage medium encoded with instructions which, when executed on a processor, perform a method for providing poker training, the method including the steps of displaying to a user a starting poker hand comprising two cards from those available from a standard deck of playing cards; displaying community cards from the standard deck of playing cards; displaying a pot value; displaying a bet value required to call; prompting the user to indicate pot odds for the starting poker hand based on the pot value and the required bet value; prompting the user to indicate an equity for the starting poker hand, the equity representing the likelihood that the user's starting poker hand will win; prompting the user to answer whether to call or fold based on the equity and the pot odds; displaying feedback as to whether the user's answer to call or fold was correct; displaying a current score based on the user's answer to call or fold; and repeating the foregoing steps for additional starting poker hands, community cards, pot values, and bet values.

In another aspect, a device is encoded with instructions perform a method for providing poker training, the method comprising the steps of displaying to a user a starting poker hand comprising two cards from those available from a standard deck of playing cards; displaying community cards from the standard deck of playing cards; displaying a pot value; displaying a bet value required to call; prompting the user to indicate pot odds for the starting poker hand based on the pot value and the required bet value; prompting the user to indicate an equity for the starting poker hand, the equity representing the likelihood that the user's starting poker hand will win; prompting the user to answer whether to call or fold based on the equity and the pot odds; displaying feedback as to whether the user's answer to call or fold was correct; displaying a current score based on the user's answer to call or fold; and repeating the foregoing steps for additional starting poker hands, community cards, pot values, and bet values.

In yet another aspect, a method for providing poker training includes displaying, on a user interface, a starting poker hand comprising two cards from those available from a standard deck of playing cards; displaying community cards from the standard deck of playing cards; displaying a pot value; displaying a bet value required to call; prompting a user to answer, using the user interface, whether to call or fold based on an equity and a pot odds associated with the user's starting poker hand; and displaying a current score based on the user's answer to call or fold.

### BRIEF DESCRIPTION OF THE DRAWINGS

The present disclosure will become more fully understood from the detailed description and the accompanying drawings, wherein:

FIG. 1 is a first display for a training home screen according to one embodiment of the present invention.

FIG. 2 is a second display for a hand ranking game according to one embodiment of the present invention.

FIG. 3 is a third display for a board reading game according to one embodiment of the present invention.

FIG. 4 is a fourth display for an expected value game according to one embodiment of the present invention.

FIG. 5 is a flow chart for a method of carrying out the expected value game of FIG. 4.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

Features of the present invention may be implemented in software, hardware, firmware, or combinations thereof. The computer programs described herein are not limited to any particular embodiment, and may be implemented in an operating system, application program, foreground or background processes, driver, or any combination thereof. The computer programs may be executed on a single computer or server processor or multiple computer or server processors.

Processors described herein may be any central processing unit (CPU), microprocessor, micro-controller, computational, or programmable device or circuit configured for executing computer program instructions (e.g., code). Various processors may be embodied in computer and/or server hardware of any suitable type (e.g., desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device”, or “device”, and multiple programmable devices in mutual communication may be referred to as a “programmable system.” It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g., internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

The training tools disclosed herein can help players memorize the ranking of poker hands, improve their speed and accuracy in reading the board, help players to determine their chances of winning a hand, help players to determine whether to call or fold based on the cards shown and the pot odds, and sharpen other skills. The system can be carried out using a computer program running on any type of computer device providing a user interface, including a computer program and a smartphone or tablet “app.” For the embodiments discussed herein, unless otherwise indicated, the standard rules (and cards) for Texas hold'em poker apply.

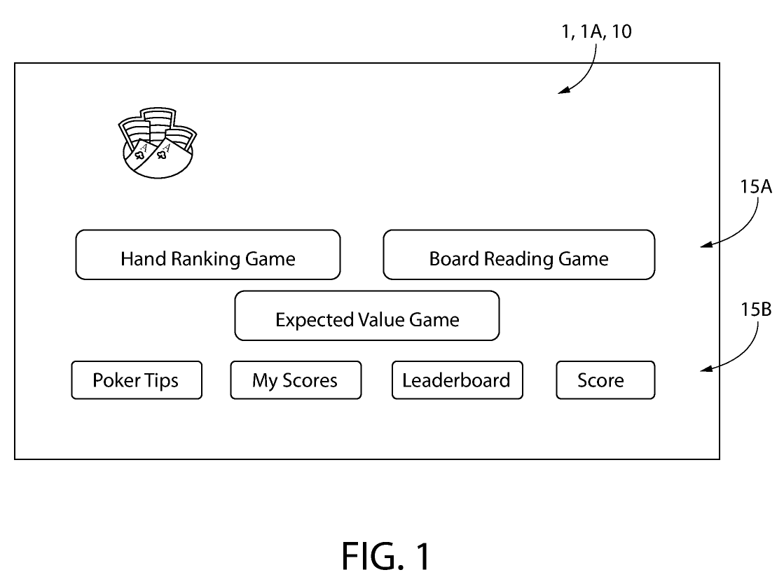

### Home Screen (FIG. 1)

Referring now to the figures, FIG. 1 is a first display 10 for a training home screen according to one embodiment of the present invention. The user interface 1, which can form part of a device 1A (e.g., a computer, smartphone, or tablet), can provide the first display 10, as well as the other displays described herein. The first display 10 includes different game options 15A, as well as additional options 15B, such as Poker Tips (for providing general poker information or information tailored to the specific user), My Scores (to show past scores for different training games), Leaderboard (to show those players with the best scores), and Share (to share information, such as scores, with others). In other embodiments, other options can be provided.

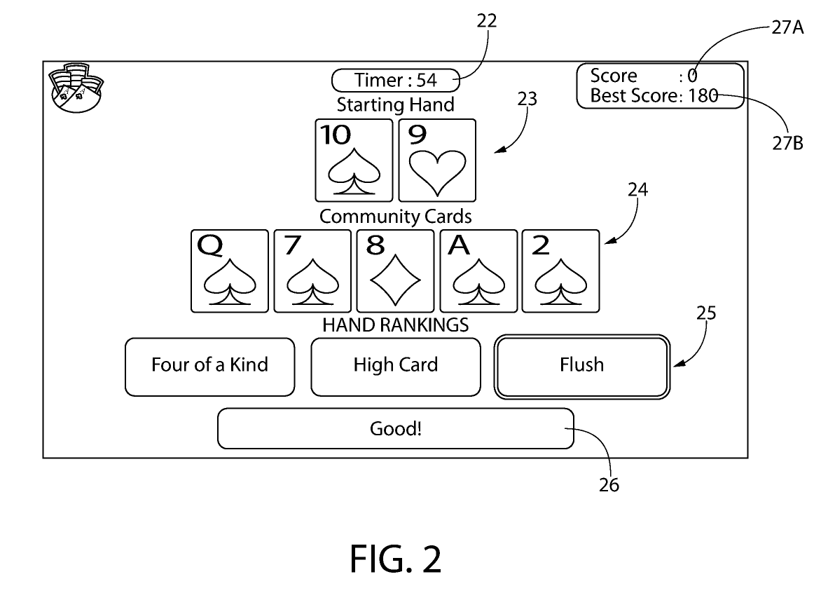

### Hand Ranking Game (FIG. 2)

FIG. 2 is a second display 20 for a hand ranking game according to one embodiment of the present invention. In this hand ranking game, a starting hand 23 is shown. In Texas hold'em, it is common that this starting hand be two card from a standard deck of 52 playing cards. Community cards 24 are also shown. In the exemplified embodiments, 5 cards are shown, thus indicating that the game has reached the “river.” In other embodiments, the community cards can be at the flop (showing 3 community cards) or the turn (showing 4 community cards). The invention, however, is not so limited. In other embodiments, other versions of poker or Texas hold'em using other numbers of starting hand or community cards can be used.

In the exemplified hand ranking game, players are dealt all the community cards 24 and a starting hand 23. The player is given different options to choose the correct hand ranking based on the universally accepted poker hand rankings. If the player chooses incorrectly, that option can come off the board and the player can choose again. If the player chooses correctly, the player can be dealt a new starting hand and community cards, as well as new hand rankings to choose from, and the process can repeat.

In the exemplified embodiment, the player must choose between the answer options 25, namely, Four of a Kind, High Card, or Flush. The player chooses correctly and receives appropriate feedback 26. In the exemplified embodiment, the feedback is a simple indication of whether or not the player has chosen correctly. In other embodiments (and for other of the games discussed herein), more detailed feedback can be provided, such as explanations as to why certain answers were correct or incorrect.

In this embodiment, the game is timed to provide a challenge. The timer 22 can show the time remaining. Any time period can be used. In the exemplified embodiment, players have 60 seconds to score as many points as they can. The highest timed scores can be applied to their “My Scores,” and they can submit their best scores to a leaderboard. An untimed version can also be provided, which can provide lower-pressure practice for beginning players to learn at their own pace. Also, the timer 22 can show the time elapsed. The foregoing can also apply to the other timers 32, 42 shown herein.

The game can also show a score 27A and a best or highest score 27B. Any scoring system can be used. In the exemplified embodiment, if players get the answer right on the first try, they receive 10 points. If they get it wrong, but then get the answer on the second try, they receive 5 points. 0 points are awarded for getting the answer on the third try. The foregoing can also apply to the other scores 37A, 47A and best scores 37B, 47B shown herein.

The different games discussed herein can also utilize starting hand constraints. In Texas hold'em there are 1326 possible starting hand combinations. Many of those hands, however, are considered unplayable or marginal. Thus, the games can have constraints so that only the top 30% of starting hands are possible.

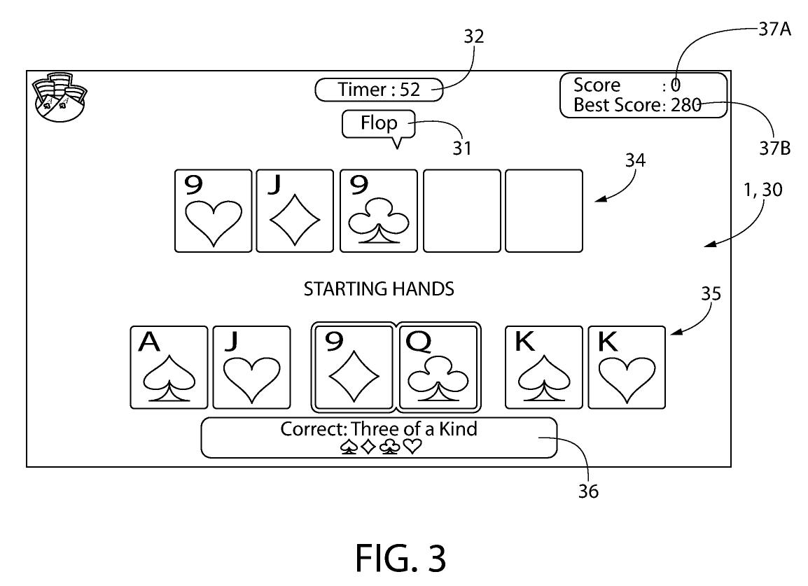

FIG. 3 is a third display 30 for a board reading game according to one embodiment of the present invention. Similar to FIG. 2, a timer 32, score 37A, and best score 37B are provided. Community cards 34 are shown, as well as an indication 31 of the stage of the hand (flop, turn, or river). Also shown are answer options 35 representing three possible starting hands. The player must choose the best starting hand based on the universally accepted poker hand rankings. In the exemplified embodiment, the player chooses correctly and receives appropriate feedback 36. In one embodiment, if the player chooses incorrectly, the incorrect chosen option fades and the player can choose again. In other embodiments, other numbers of options can be provided, and different feedback (such as that discussed with regard to FIG. 2) can be provided.

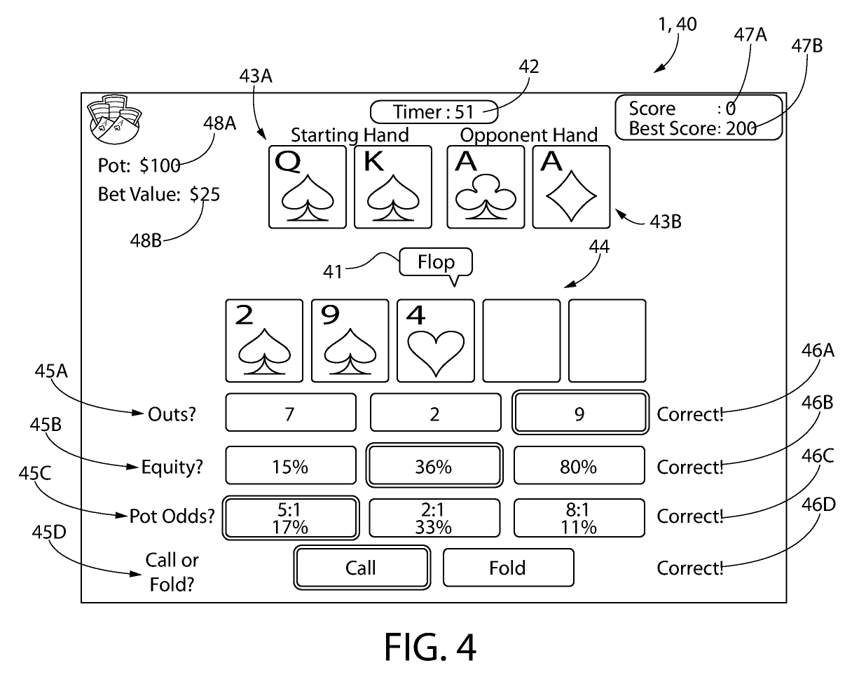

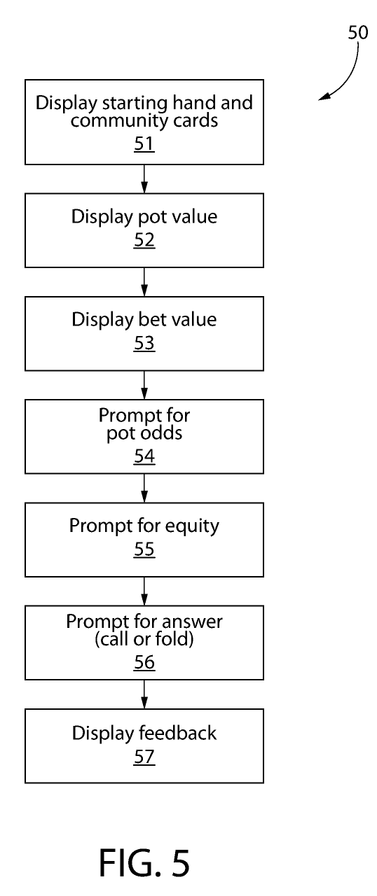

### Expected Value Game (FIG. 4-5)

FIG. 4 is a fourth display 40 for an expected value game according to one embodiment of the present invention. In this game, a player can be dealt a starting hand 43A and be up against an opponent's hand 43B. (In other embodiments, the opponent's hand 43B can be omitted.) In this embodiment, the player's hand is behind. Community cards 44 can be dealt. The player can determine his or her number of outs and calculate his or her equity. Players can also determine whether they have the right odds to call on the flop and turn in comparison to their pot odds. This will help players practice whether or not they have positive or negative expected value in common poker scenarios, and thereby determine whether a decision will be profitable in the long run. The display 40 can further include features such as a timer 42, a score indicator 47A, and a best score indicator 47B. The display can also indicate the pot value 48A, the opponent bet value 48B, and an indication of the stage of the game 41.

### Outs

In this embodiment, the player is first prompted 45A to indicate the outs available based on the starting poker hand 43A and the community cards 44 displayed. As used herein, the term “outs” refers to the number of unseen cards yet to come that if drawn will likely improve a player's hand to win. Knowing the number of outs is an important strategic advantage because outs can be used to calculate equity, or the chance of having the best hand by the river.

In the exemplified embodiment, the player is holding a flush draw with a QcKc hand 43A on a 2c9c4h board 44 (where “c” represents clubs, “h” represents hearts, “d” represents diamonds, and “s” represents spades). In other words, the player has four clubs and needs just one more for a flush. There are 13 total club cards in a standard deck of cards. If one subtracts 4 (the already exposed club cards) from the 13 total club cards, there are 9 club cards that may be turned to form part of the community cards 44. Thus, the player has 9 outs. If one of these nine cards is turned to become part of the community cards 44, the player will have a flush, which will likely beat the opponent's hand.

In this embodiment, the player chooses the correct number of outs and receives feedback 46A indicating that the selection is correct. In other embodiments, the feedback can be omitted or take a different form (e.g., explain how the outs were calculated). Further, in this embodiment, the user chooses from multiple choices. In other embodiments, the user can indicate his or her choice by other means, such as by typing a number in free-form.

### Equity

The player is further prompted 45B to determine the equity for his or her hand. As used herein, the term “equity” refers to the probability of making (winning) a hand. The number of outs can be used to calculate the probability of making a hand. In one embodiment, one can divide the number of outs by the remaining unknown cards. In another embodiment, a shortcut rule of “4 and 2” can be used. By this method, on the flop the player can multiply his or her outs by 4, and on the turn multiply his or her outs by 2.

For example, if the community cards from the flop are 3c7cTh, the opponent's hand is AsAh, and the player's hand is AcKc, the player has 9 outs. Multiplying 9 times 4 results in a percentage of 36%. This closely approximates the answer obtained when dividing the number of outs by the remaining unknown cards (37.3%). If on the turn a 5d is turned, the community cards are now 3c7cTh5d. The player still has 9 outs, but only one additional card will be revealed, so a multiplier of 2 is used. Multiplying 9 times 2 results in a percentage of 18%. This closely approximates the answer obtained when dividing the number of outs by the remaining unknown cards (20.5%).

In the exemplified embodiment shown in FIG. 4, the player is holding a flush draw with QcKc on a 2c9c4h board. Taking into account the number of flush outs (9), including the turn and river, the player has about an equity of about 36%, that is, about a 36% chance of winning the hand. Accordingly, the user selects this option and receives feedback 46B indicating that this answer is correct.

### Pot Odds

The player is prompted 45C to determine the pot odds for his or her hand. As used herein, the term “pot odds” means the ratio of the current size of the pot to the cost of a potential call, or the corresponding percentage. In the exemplified embodiment of FIG. 4, the pot size or pot value 48A is shown to be $100. Further, the bet value 48B is shown to be $25. Thus, the player must spend $25 for a chance to win $125 (pot value+bet value). Accordingly, the pot odds are 125:25, or 5:1, or 17% (⅙). Accordingly, the user selects this option and receives feedback 46C indicating that this answer is correct.

### Expected Value

Finally, the player is prompted 45D to provide an answer as to whether to call or fold. In making this determination, the player can determine whether there is positive expected value. Whether there is positive expected value can be determined by examining the equity and the pot odds. If the equity (the chance of winning the hand) is greater than the pot odds, then there is positive expected value. In the exemplified embodiment of FIG. 4, the equity is 36% and the pot odds are 17%. Thus, there is positive equity, and therefore the player should call. Accordingly, the user selects this option and receives feedback 46D indicating that this answer is correct. In other embodiments, the method of feedback can vary. For example, in some embodiments, if at any stage a wrong answer is provided, a new hand and new community cards can be displayed. Further, certain prompts (e.g., the prompt 45A for the number of outs) can be omitted.

This training method provides several advantages. It teaches a player to consider both the chances of winning a hand (equity), the amount that must be wagered (bet value), and the amount that may be won (pot value and bet value), to determine whether to call or fold. The player must determine whether a decision to call or fold is profitable in the long run based on the probability and payout. By providing training in the form of a computer game (as opposed to in-person training), the user can practice in private and at his own convenience, and can receive a score to quantify and keep track of his progress. For example, the user can compare his recent score to his earlier scores, or the scores of other players. The games provide a convenient means by which a player can improve his decisions and increase the speed with which he makes those decisions.

FIG. 5 is a flow chart for a method of carrying out the expected value game of FIG. 4. According to this embodiment, a starting poker hand is displayed comprising two cards from those available from a standard deck of playing cards; and community cards are displayed from the standard deck of playing cards (collectively, operation 51). Further, a pot value is displayed (operation 52). Further, a bet value required to call is displayed (operation 53). Further, the user is prompted to indicate pot odds for the starting poker hand based on the pot value and the required bet value (operation 54). Further, the user is prompted to indicate an equity for the starting poker hand, the equity representing the likelihood that the user's starting poker hand will win (operation 55). Further, the user is prompted to answer whether to call or fold based on the equity and the pot odds (operation 56). Further, feedback is displayed indicating whether the user's answer to call or fold was correct (operation 57).

It is noted the order of the operations or steps indicated above can vary. Further, certain operations or steps can be omitted. Further, while in the exemplified embodiment the options are provided in multiple choice format, other formats (e.g., a free-form text box) can be used. Further, while feedback is provided for each of the prompts, the invention is not so limited. For example, in certain embodiments, feedback for prompts 45A, 45B, 45C can be omitted and a single feedback can be provided after prompt 45D. Further, while in the exemplified embodiment the prompts 45A, 45B, 45C, 45D are shown on a single display, in other embodiments one or more prompts can be shown on different screens (e.g., one question at a time).

Additional Features

The poker training user interface 1 can provide other features. For example, a market economy like Candy Crush can be used. Players can have a certain amount of starting chips and can earn more chips in various ways (e.g., replenish chips every 24 hours, earn more chips through practice, purchase more chips through an app store, or win chips from friends (the “Pot”)). This may be done like “words with friends,” where players do not need to be on at the same time, but instead will send a challenge correspondence. Player A goes through a series of questions in 60 seconds, then challenges Player B to the same set of questions. Whoever gets the most right in 60 seconds wins the “Pot.” For example, a player can start with 500 chips and challenge friends to 100 chips. A player can earn 10 chips for every perfect flop, turn, river. A player can buy 500 chips for $0.99, 2500 for $3.99, 7500 for $6.99.

Further, players can have the ability to set which range of hands they want to play against. This allows for players to practice against players who are tighter (plays fewer hands) and also players who are looser (play more hands). By this feature, players can more easily recognize the types of hands they are up against, which will help them make better adjustments when they sit to play a real game of poker.

Although the aforementioned game types are randomized and allow for practice reading the board, a board texture constraint feature can allow users to control the type and frequency of hands (straights, flushes, full houses) to practice with. In “Flush Draw Flop,” there are two cards of the same suit meaning the most a player could have is four cards of the same suit. A player with a flush draw has two chances of hitting their flush on the turn or river. In “Suited Flop,” all three cards are the same suit. These boards are dangerous because someone could already have a flush, and someone with one of the suit in their hand now has a draw. In “Paired Flop,” when the board has a pair, the possible hands available increase to include full houses and four of a kinds. The player can immediately realize that it's now possible for opponents to be holding these huge hands.

While the invention or inventions have been described with respect to specific examples, those skilled in the art will appreciate that there are numerous variations and permutations of the above described invention(s). It is to be understood that other embodiments may be utilized and structural and functional modifications may be made without departing from the scope of the present invention(s). Thus, the spirit and scope should be construed broadly as set forth in the appended claims.

What is claimed is:

1. A non-transitory computer-readable storage medium encoded with instructions which, when executed on a processor, perform a method for providing poker training, the method comprising the steps of:
displaying on a user interface:
a starting poker hand comprising two cards from those available from a standard deck of playing cards;
community cards from the standard deck of playing cards;
a pot value; and
a bet value required to call;
prompting a user to indicate pot odds for the starting poker hand based on the pot value and the required bet value;
prompting the user to indicate an equity for the starting poker hand, the equity representing the likelihood that the user's starting poker hand will win;
prompting the user to answer whether to call or fold based on the equity and the pot odds;
displaying feedback as to whether the user's answer to call or fold was correct;
displaying a current score based on the user's answer to call or fold; and
repeating the foregoing steps for additional sets of starting poker hands, community cards, pot values, and bet values.

2. The method of claim 1 further comprising:
prompting the user to indicate a number of outs available based on the starting poker hand and the community cards displayed, the outs representing the number of cards from the standard deck of playing cards that are not currently displayed and that would provide the user a winning hand or a likely winning hand.

3. The method of claim 2 wherein the equity is based on the number of outs.

4. The method of claim 1 further comprising:
displaying to a user an opponent's starting poker hand comprising two additional cards from those available from a standard deck of playing cards;
wherein the equity is based on a number of outs available, the number of outs based on the starting poker hand, the opponents starting poker hand, and the community cards displayed.

5. The method of claim 1 wherein the feedback as to whether the user's answer was correct is based on whether the equity exceeds the pot odds.

6. The method of claim 1 wherein the displayed community cards comprise a total of three, four, or five cards.

7. The method of claim 1 further comprising:
displaying an indication as to whether the user's equity indication is correct; and
displaying an indication as to whether the user's pot odds indication is correct.

8. The method of claim 1 further comprising:
displaying a timer indicating a time remaining.

9. The method of claim 1 wherein the equity is indicated by the user selecting one of several equity options.

10. The method of claim 1 wherein the equity is indicated by the user entering either a number representing a percentage or two numbers representing odds.

11. The method of claim 1 wherein the pot odds are indicated by the user selecting one of several pot odds options.

12. The method of claim 1 wherein the pot odds are indicated by the user entering either a number representing a percentage or two numbers representing odds.

13. A device encoded with instructions which perform a method for providing poker training, the method comprising the steps of:
displaying on a user interface:
a starting poker hand comprising two cards from those available from a standard deck of playing cards;
community cards from the standard deck of playing cards;
a pot value; and
a bet value required to call;
prompting the user to indicate pot odds for the starting poker hand based on the pot value and the required bet value;
prompting the user to indicate an equity for the starting poker hand, the equity representing the likelihood that the user's starting poker hand will win;
prompting the user to answer whether to call or fold based on the equity and the pot odds;
displaying feedback as to whether the user's answer to call or fold was correct;
displaying a current score based on the user's answer to call or fold; and
repeating the foregoing steps for additional sets of starting poker hands, community cards, pot values, and bet values.

14. The device of claim 13 wherein the method further comprises the step of:
prompting the user to indicate a number of outs available based on the starting poker hand and the community cards displayed, the outs representing the number of cards from the standard deck of playing cards that are not currently displayed and that would provide the user a winning hand or a likely winning hand.

15. The device of claim 14 wherein the equity is based on the number of outs.

16. The device of claim 13 wherein the method further comprises the step of:
displaying to a user an opponent's starting poker hand comprising two additional cards from those available from a standard deck of playing cards;
wherein the equity is based on a number of outs available, the number of outs based on the starting poker hand, the opponents starting poker hand, and the community cards displayed.

17. The device of claim 13 wherein the feedback as to whether the user's answer was correct is based on whether the equity exceeds the pot odds.

18. The device of claim 13 wherein the displayed community cards comprise a total of three, four, or five cards.

19. The device of claim 13 wherein the method further comprises the step of:
displaying an indication as to whether the user's equity indication is correct; and
displaying an indication as to whether the user's pot odds indication is correct.

20. A method for providing poker training, the method comprising the steps of:
displaying on a user interface:
a starting poker hand comprising two cards from those available from a standard deck of playing cards;
community cards from the standard deck of playing cards;
a pot value; and
a bet value required to call;
prompting a user to answer, using the user interface, whether to call or fold based on an equity and a pot odds associated with the user's starting poker hand; and
displaying a current score based on the user's answer to call or fold.
